(19) United States
(12) Patent Application Publication
(10) Pub. No.: US 2007/0273227 A1
(43) Pub. Date: Nov. 29, 2007

(54) Fan and inner-rotor type motor thereof

(75) Inventors: Chung-Kai Lan, Taoyuan Hsien (TW); Hung-Chi Chen, Taoyuan Hsien (TW); Te-Tsai Chuang, Taoyuan Hsien (TW)

Correspondence Address: BIRCH STEWART KOLASCH & BIRCH, PO BOX 747, FALLS CHURCH, VA, 22040-0747, US

(73) Assignee: DELTA ELECTRONICS, INC.

(21) Appl. No.: 11/790,634

(22) Filed: Apr. 26, 2007

(30) Foreign Application Priority Data
May 26, 2006 (TW) 095118731

(51) Int. Cl. H02K 11/00; H02K 5/00

(52) U.S. Cl. 310/89; 417/423.14; 310/68 R

(57) ABSTRACT

A fan includes an inner-rotor type motor and an impeller. The inner-rotor type motor includes a housing, a stator structure, a rotor structure and a driving device. The stator structure has a magnetically conducting element. The rotor structure includes a shaft and a magnetic element. The shaft passes through the housing. The magnetic element mounts on the shaft and is disposed corresponding to the magnetic conducting element. The driving device is electrically connected with the magnetically conducting element. The stator structure, the rotor structure and the driving device are accommodated in the housing. The impeller is connected to the shaft.

### CROSS REFERENCE TO RELATED APPLICATIONS

This Non-provisional application claims priority under 35 U.S.C. §119(a) on Patent Application No(s). 095118731, filed in Taiwan, Republic of China on May 26, 2006, the entire contents of which are hereby incorporated by reference.

### BACKGROUND OF THE INVENTION

1. Field of Invention

The invention relates to a fan and its motor, and in particular to a fan and its motor with an inner rotor.

2. Related Art

Motors function to transform electricity to mechanical energy and are applied to many mechanical structures. Nowadays, there are many kinds of motors available, and they are roughly divided into brushless motors and brush motors.

As shown in FIG. 1, a conventional brushless motor 1 can drive an impeller of a fan to rotate. The brushless motor 1 has a bearing structure 10, a rotor structure 11, a stator structure 12, and a circuit board 13. The bearing structure 10 includes a bearing tube 101 and a bearing 102 disposed in the bearing tube 101. The rotor structure 11 includes a shaft 111, a magnetically conducting case 112 and a magnetic element 113. One end of the shaft 111 is embedded in the magnetically conducting case 112. The magnetic element 113 is disposed around the inner wall of the magnetically conducting case 112. The bearing 102 mounts on the shaft 111. The stator structure 12 includes a plurality of windings 121, which are disposed opposite to the magnetic element 113. The bearing tube 101 passes through the circuit board 12, and the circuit board 12 is disposed on the bearing structure 10. The circuit board 12 is capable of controlling the current direction of the windings 121 to produce magnetic interaction with the magnetic element 113 of the rotor structure 11. Accordingly, the rotor structure 11 can be driven to rotate.

When the fan operates, the outer portion of the brushless motor 1, which is a typical outer-rotor type motor, rotates. However, the brushless motor 1 has many assembling gaps between its components, so it is not very airtight, which results in poor protection of the internal elements. For example, there are many gaps G between the rotor structure 11 and the bearing structure 10. Thus, debris or vapor may easily enter the motor from the gaps G This damages the components of the motor and thus decreases the lifetime of the motor.

Therefore, it is an important subjective to provide a fan and a motor thereof, which is more airtight so as to protect the components of the motor and extend its lifetime.

### SUMMARY OF THE INVENTION

In view of the foregoing, the invention is to provide a fan and an inner-rotor type motor thereof, which are more airtight.

To achieve the above, the present invention discloses an inner-rotor type motor, which includes a housing, a stator structure, a rotor structure and a driving device. The stator structure has a magnetically conducting element. The rotor structure includes a shaft and a magnetic element. The shaft passes through the housing. The magnetic element mounts on the shaft and is disposed corresponding to the magnetic conducting element. The driving device is electrically connected with the magnetically conducting element. The stator structure, the rotor structure and the driving device are accommodated in the housing.

To achieve the above, the present invention also discloses a fan including an inner-rotor type motor and an impeller. The inner-rotor type motor includes a housing, a stator structure, a rotor structure and a driving device. The stator structure has a magnetically conducting element. The rotor structure includes a shaft and a magnetic element, and the shaft passes through the housing. The magnetic element mounts on the shaft and is disposed corresponding to the magnetic conducting element. The driving device is electrically connected with the magnetically conducting element. The stator structure, the rotor structure and the driving device are accommodated in the housing. The impeller is connected with the shaft.

As mentioned above, the fan and inner-rotor type motor have a housing for accommodating the stator structure, rotor structure and driving device. Therefore, the present invention provides the inner rotor structure to substitute the outer rotor structure of the conventional brushless motor. Thus, the efficiency and reliability of the brushless motor can be increased. Also, the motor structure of the present invention is highly airtight. This can enhance the protection effect of the inner components of the motor and allow the motor to be manufactured without a motor cover.

### BRIEF DESCRIPTION OF THE DRAWINGS

The invention will become more fully understood from the detailed description given herein below illustration only, and thus is not limitative of the present invention, and wherein:

FIG. 1 is a schematic view showing a conventional brushless motor;

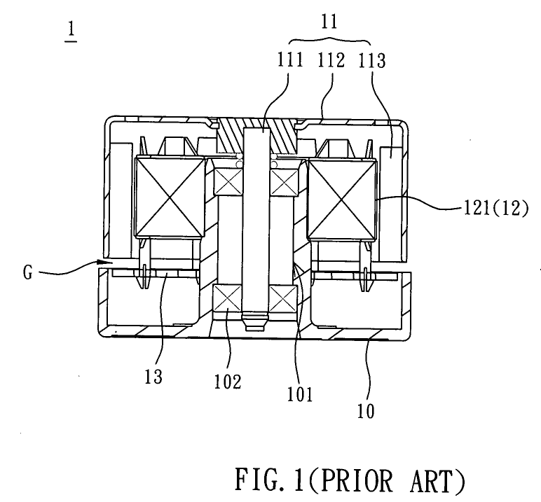

FIG. 2 is an exploded view of an inner-rotor type motor according to an embodiment of the present invention;

FIG. 3 is a schematic view showing the assembled inner-rotor type motor of FIG. 2; and

FIG. 4 is a schematic view showing a fan according to an embodiment of the present invention.

### DETAILED DESCRIPTION OF THE INVENTION

The present invention will be apparent from the following detailed description, which proceeds with reference to the accompanying drawings, wherein the same references relate to the same elements.

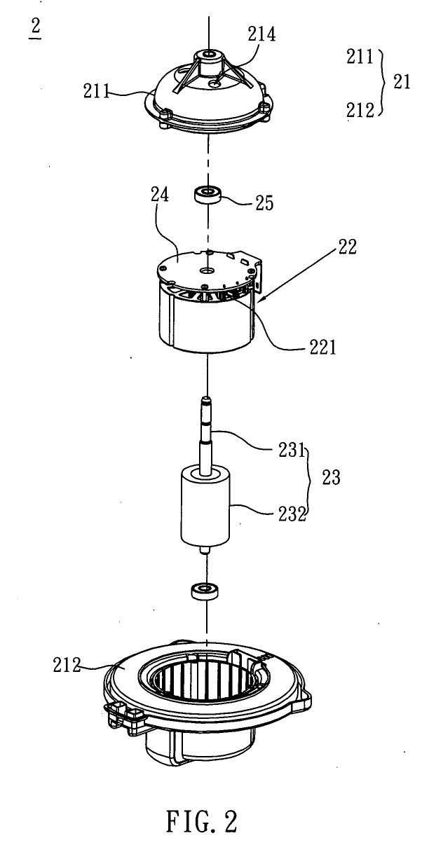

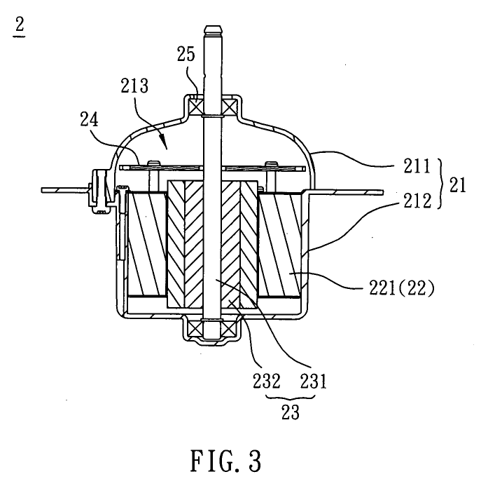

With reference to FIG. 2 and FIG. 3, an inner-rotor type motor 2 according to an embodiment of the invention includes a housing 21, a stator structure 22, a rotor structure 23, and a driving device 24.

In the embodiment, the housing 21 is composed of a first housing 211 and a second housing 212, which are connected with each other to provide a space 213 therebetween. The first housing 211 or the second housing 212 can be made of metal or plastic. In addition, as shown in FIG. 2, the first housing 211 or the second housing 212 has at least one heat-dissipation hole 214 for dissipating heat generated during the operation of the motor 2.

The stator structure 22 includes a magnetically conducting element 221 disposed around the inner wall of the second housing 212. In the embodiment, the magnetically conducting element 221 includes at least one silicon steel lamination and at least one winding, which is wound on the silicon steel lamination (not shown).

The rotor structure 23 is disposed in the space 213 of the housing 21, and includes a shaft 231 and a magnetic element 232. The magnetic element 232 mounts on the shaft 231 and is disposed corresponding to the magnetic conducting element 221. The shaft 231 passes through the first housing 211, and a part of the shaft 231, which is exposed from the first housing 211, is used as a driving shaft for connecting with other components. In the embodiment, the magnetic element 232 includes at least one permanent magnet, which generates magnetic interaction with the corresponding windings of the magnetically conducting element 221 when current is applied.

The driving device 24 is also disposed in the space 213 and is electrically connected with the magnetically conducting element 221 so as to control, in particular, the current direction of the windings. As the results, the magnetically conducting element 221 and the magnetic element 232 can generate alternating magnetic fields and drive the rotor structure 23 to rotate. In the embodiment, the driving device 24 is a circuit board. In different structural designs, the shaft 231 can pass through the driving device 24, and the driving device 24 is disposed between the first housing 211 and the stator structure 22 or between the second housing 212 and the stator structure 22.

With reference to FIG. 3, the inner-rotor type motor 2 further includes a bearing 25, which is disposed in the housing 21 and mounts on the shaft 231. The bearing 25 can maintain the smooth rotation of the shaft 231. In the embodiment, the bearing 25 can be a sleeve bearing or a ball bearing.

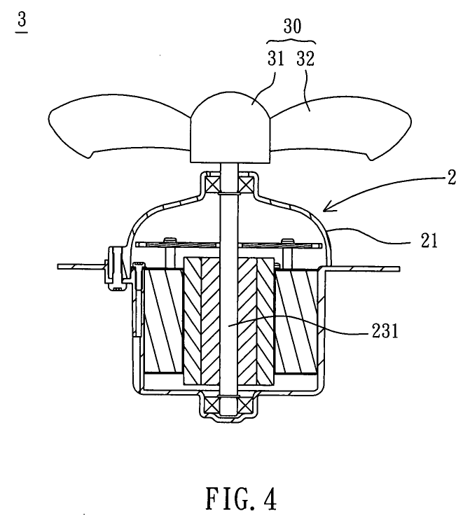

With reference to FIG. 4, a fan 3 according to the embodiment of the present invention includes an inner-rotor type motor 2 and an impeller 30. In the embodiment, the fan 3 is used for a vehicle. The inner-rotor type motor 2 is described in the previous embodiment, so the detailed descriptions are omitted.

The impeller 30 includes a hub 31 and a plurality of blades 32 disposed around the hub 31. The hub 31 is connected with the part of the shaft 231 exposed from the housing 21. Thus, when the inner-rotor type motor 2 rotates, the impeller 30 is driven to rotate. This will cause an airflow for heat dissipation, for example.

In summary, the fan and inner-rotor type motor have a housing for accommodating the stator structure, rotor structure and driving device. Therefore, the present invention provides the inner rotor structure to substitute for the outer rotor structure of the conventional brushless motor. Thus, the efficiency and reliability of the brushless motor can be improved. In addition, the motor structure of the invention is highly airtight. This can enhance the protection effect of the inner components of the motor and can allow the motor to be manufactured without a motor cover.

Compared with the prior art, the rotor structure of the invention can rotate within the housing, so debris and vapor can not enter the core structure of the motor. Thus, the components of the motor can be efficiently protected, and the lifetime of the fan and the motor can be extended. Also, since the magnetic conducting element of the rotor structure mounts on the shaft, the housing can be made of plastic, in contrast with the magnetic conducting case of the conventional brushless motor that is made of metal to enable magnetic conduction. Thus, the weight and cost of the motor can be reduced so as to satisfy the demand for ever lighter and more compact devices.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. An inner-rotor type motor, comprising:
a housing;
a stator structure having a magnetically conducting element;
a rotor structure comprising a shaft and a magnetic element, wherein the shaft passes through the housing, and the magnetic element mounts on the shaft and is disposed corresponding to the magnetic conducting element; and
a driving device electrically connected with the magnetically conducting element, wherein the stator structure, the rotor structure and the driving device are accommodated in the housing.

2. The motor according to claim 1, wherein the housing comprises a first housing and a second housing connected with each other.

3. The motor according to claim 2, wherein the first housing and the second housing comprise metal or plastic.

4. The motor according to claim 2, wherein the first housing or the second housing has at least one heat-dissipation hole.

5. The motor according to claim 2, wherein the shaft passes through the driving device, and the driving device is located between the first housing and the stator structure.

6. The motor according to claim 2, wherein the shaft passes through the driving device, and the driving device is located between the stator structure and the second housing.

7. The motor according to claim 1, further comprising at least one bearing disposed in the housing and mounting on the shaft.

8. The motor according to claim 1, wherein the driving device is a circuit board.

9. The motor according to claim 1, wherein the magnetic element comprises at least one permanent magnet.

10. A fan, comprising:
an inner-rotor type motor, comprising a housing, a stator structure, a rotor structure and a driving device, wherein the stator structure has a magnetically conducting element, the rotor structure comprises a shaft and a magnetic element, the shaft passes through the housing, the magnetic element mounts on the shaft and is disposed corresponding to the magnetic conducting element, the driving device is electrically connected with the magnetically conducting element, and the stator structure, the rotor structure and the driving device are accommodated in the housing; and
an impeller connected with the shaft.

11. The fan according to claim 10, wherein the housing comprises a first housing and a second housing connected with each other.

12. The fan according to claim 11, wherein the first housing and the second housing comprise metal or plastic.

13. The fan according to claim 11, wherein the first housing or the second housing has at least one heat-dissipation hole.

14. The fan according to claim 11, wherein the shaft passes through the driving device, and the driving device is located between the first housing and the stator structure.

15. The fan according to claim 11, wherein the shaft passes through the driving device, and the driving device is located between the stator structure and the second housing.

16. The fan according to claim 10, wherein the motor further comprises at least one bearing disposed in the housing and mounting on the shaft.

17. The fan according to claim 10, wherein the driving device is a circuit board.

18. The fan according to claim 10, wherein the magnetic element comprises at least one permanent magnet.

19. The fan according to claim 10, wherein the impeller comprises a hub and a plurality of blades disposed around the hub, and the hub is connected with one part of the shaft and is exposed from the housing.

20. The fan according to claim 10, wherein the fan is for a vehicle.
